(19) United States
(12) Patent Application Publication
(10) Pub. No.: US 2026/0340342 A1
(43) Pub. Date: Oct. 29, 2026

(54) INDEPENDENT SPLIT MODEL INFERENCE IN SPLIT NEURAL NETWORK FOR ESTIMATING NETWORK PARAMETERS

(71) Applicant: Telefonaktiebolaget LM Ericsson (publ), Stockholm (SE)

(72) Inventors: Selim ICKIN, Danderyd (SE); Dinand ROELAND, Sollentuna (SE); Göran HALL, Mölndal (SE)

(73) Assignee: Telefonaktiebolaget LM Ericsson (publ), Stockholm (SE)

(21) Appl. No.: 19/110,217

(22) PCT Filed: Sep. 8, 2023
(86) PCT No.: PCT/EP2023/074761

§ 371 Date: Mar. 10, 2025

Related U.S. Application Data
(60) Provisional application No. 63/405,780, filed on Sep. 12, 2022.

(51) Int. Cl. G06N 3/045; G06N 3/048

(52) U.S. Cl. CPC G06N 3/045; G06N 3/048

(57) ABSTRACT

A split neural network includes a tail network model that receives a first plurality of activations and a second plurality of activations at a cut layer of the split neural network, and that generates a model output in response to the first plurality of activations and the second plurality of activations; a head network model that receives a plurality of input feature values and generates the first plurality of activations in response to the plurality of input feature values and provides the first plurality of activations to the tail network model at the cut layer; and a translator model that receives the first plurality of activations, that generates estimated values of the second plurality of activations in response to the first plurality of activations, and that provides the estimated values of the second plurality of activations to the tail network model at the cut layer.

### TECHNICAL FIELD

The present disclosure relates to machine learning models for estimating parameters in communication networks, and in particular to split models that estimate network parameters.

### BACKGROUND

Quality of experience (QoE) is a measure of overall user satisfaction with a service, such as a telecommunication service. In the telecommunication environment QoE is typically measured using a Mean Opinion Score (MOS) metric. For a network operator, it is important to know the QoE experienced by end users, as a poor QoE might cause end-user customers of network operators to leave the service. It is therefore important for network operators to have an accurate and robust QoE estimation tool. If the estimated QoE is bad, the operator may change one or more configurations in the network to improve the QoE.

One way for a network operator to estimate the current QoE of its end users is shown in FIG. 1, which illustrates a user equipment (UE) that accesses remote services from an application server (AppServer) via a communication network that includes a user plane and a control plane. The application (such as a video streaming application) runs at the UE with the backend running at the AppServer (for example, a Netflix application running in a browser at the UE, with the Netflix server running at the AppServer). The application would inform the control plane of the operator's network about the currently perceived QoE. The operator may take action by reconfiguring the user plane.

Although the approach shown in FIG. 1 is feasible and has been incorporated into standards, there are several disadvantages. One main disadvantage relates to scaling. During deployment, for every application session, the AppServer would need to send information to the control plane of the network. Another disadvantage is privacy, as it reveals user data related to end-user perceived quality to the network operator.

It would be better if the operator could measure QoE based on data that is already available inside the communication network without needing extra information from the UE and/or the AppServer. One way to achieve this is to train a Machine Learning (ML) model to predict QoE based on input features available in the user plane of the communication network. This approach is illustrated in FIG. 2. In this approach, QoE (in the form of MOS) is provided as labels from the AppServer during training. QoE would be provided per-UE for a given time interval. This can be correlated to data from the user plane, such as bandwidth, latency, and loss for the given UE at the given time interval.

Even though the setup shown in FIG. 2 may solve the scalability issue, the resulting model, which uses only observations from network control plane, may tend to perform poorly. One proposal to improve this would be to use federated learning as illustrated in FIG. 3. As shown in FIG. 3, the UE, network and AppServer each train a local model. Outputs of the local models are provided to a master model. The UE trains its local model using inputs such as bandwidth, latency, packet loss, etc. The network trains its local model using inputs such as access speed, delay, etc. The AppServer trains its local model using inputs such as stall time/frequency, etc. Each of the local models and the master model may include neural network (NN) models.

The procedure during the training of this setup is the following:

First, the UE(s), network, and AppServer each train their local model. All use MOS as the training labels, which comes from the AppServer (or, alternatively, from the UEs).

The local models are sent to a master trainer, which creates the master model from the received local models. The master model is sent to UE(s), network, and AppServer. At each location, the master model is used as the new local model, and the procedure is repeated.

With this setup, the network would eventually have a local model based on the master model. The assumption is that such model would perform better compared to a local model with only local input (the previous setup).

One disadvantage of the federated learning approach shown in FIG. 3 is that it requires at least a few input training features (or attributes) to be common in all local nodes. Even if there exist some common features, aligning the different local models on their input features poses some extra challenges. For example, this might reveal privacy-sensitive information, as they need to share statistics of every feature (if not the sensitive feature names). Moreover, aligning the features may require additional computation complexity and signaling overhead. In fact, observations at the communication network might be very different than the observations at the AppServer or at the UE. Therefore, the NN architectures at the collaborating nodes may often be very different depending on the number of features available at each node. If a node has a very large number of features, limiting the local node with a small NN impacts accuracy. This is true also vice-versa: it is also not preferred for very large NN model architectures to be trained on a few samples and attributes.

Split learning (SL) is a method that addresses the challenge of training a joint model without requiring that the local models have the same input features or even the same neural network architectures. In SL, a model is divided into one or more head nodes (or clients), which contain local split model portions, and one or more tail nodes (or servers), which contain a master split model portion. For simplicity, only a single tail node is illustrated in FIG. 4. The head nodes only share their encoded outputs with the tail node, as shown in FIG. 4. The setup shown in FIG. 4 is referred to as a decentralized split, since multiple head nodes/local models are involved.

The operation of a SL system involves a training phase in which the models of the system are trained and an inference phase in which the system models are used to obtain a prediction of a desired value.

In the context of a communication system, the training procedure in a SL system is as follows. First, the head nodes (UE(s), network, and AppServer) train jointly. Synchronization is accomplished using, for example, UE ID and time, e.g., hour of the day. Each local split model portion has its own input layer (feature space) and its own output layer.

No raw data is exchanged in the training phase. What is exchanged is only the signaling between the local model portions' output (last) layer and the master split model's input (first) layer.

The last layer of the master model uses MOS (or, in general, some user rating) as the label for the output.

Split Learning (SL) was first introduced to alleviate some of the concerns of federated learning, such as scalability. In SL, some of the heavy computation at the clients can be offloaded to the server. SL has advantages over FL when there are many collaborating clients with large sized models (consisting of many layers and neurons). The inherently distributed observations are then combined to form an estimate of some value. These observations at the local client nodes that are shared with the “master” (or driver) are encoded form and are obtained at the end of the cut-layer. The encoded outputs are referred to as activations.

Split learning not only addresses the privacy issues, but it also potentially reduces the computation overhead on the clients by offloading the forward- and backwards propagation to the server model (typically, a neural network, or NN), which makes it especially suitable in computation limited internet of things (IoT) devices.

FIG. 5 illustrates a split learning model 500 in a telecommunication environment that includes three head nodes, namely, a network, an AppServer, and a UE, that manage respective local head models 512A, 512B, 512C, and one tail node (in this example, the network) that manages a tail model 514. The head models 512A, 512B, 512C and the tail model 514 are separated at a cut layer 540. In a training phase, a forward pass is performed on the head models 512A-512C at the head nodes using input features 520, and the inferred values are transmitted to the tail model 514. The tail node performs a forward pass based on the inferred values provided by the head nodes to obtain a prediction. Based on the error of the prediction, the tail node then computes gradients at the cut-layer 540 and returns the computed gradients to the head nodes.

Decentralized Split Learning is a suitable method for training QoE estimation models, since the decentralized observations at the head nodes can still be collected individually and with different local neural network models, while at the same time the learnings can be joined in a common server at the tail node (driver node). In FIG. 5, there are local models at the head nodes for the network, AppServer and UE. The local model on the right-hand side (which can include both a head and a tail node) acts as a final trainer, and holds the ML labels, such as MOS.

### SUMMARY

A split neural network according to some embodiments includes a tail network model that receives a first plurality of activations and a second plurality of activations at a cut layer of the split neural network, and that generates a model output in response to the first plurality of activations and the second plurality of activations, a head network model that receives a plurality of input feature values and generates the first plurality of activations in response to the plurality of input feature values and provides the first plurality of activations to the tail network model at the cut layer, and a translator model that receives the first plurality of activations, generates estimated values of the second plurality of activations in response to the first plurality of activations, and provides the estimated values of the second plurality of activations to the tail network model at the cut layer.

The head network model may include a first head neural network of the split neural network and the tail network model may include a tail neural network of the split neural network. The translator model may include a neural network or a tree-based machine learning model.

The plurality of input feature values may include a first plurality of input feature values, and the translator model may predict an output of a second head neural network of the split neural network. The second head neural network is configured to generate, during a training phase, the second plurality of activations in response to a second plurality of input feature values that are different from the first plurality of input feature values.

The plurality of input feature values may include features related to the operation of a wireless communication network, and wherein the model output may include a key performance indicator, KPI, of the wireless communication network.

The model output may include a quality of experience, QoE, metric of the wireless communication network.

The first plurality of input features may include network features of a wireless communication network and the second plurality of input features may include application or user equipment features of the wireless communication network.

The head network model and the tail network model may be implemented in different network functions of a wireless communication network.

The head network model may include a first head network model that is trained as part of a neural network model that includes a second head network model that generates the second plurality of activations during a training phase.

The first head network model, the tail network model and the translator model may be operated by a communication network, and the second head network model is operated by an application server that is outside the communication network.

A method of operating a split neural network according to some embodiments includes receiving, at a head network model, a plurality of input feature values, generating, by the head network model, a first plurality of activations in response to the plurality of input feature values, and providing, by the head network model, the first plurality of activations to a translator model and to a tail network model at a cut layer of the split neural network. The translator model receives the first plurality of activations, generates estimated values of a second plurality of activations in response to the first plurality of activations, and provides the estimated values of the second plurality of activations to the tail network model at the cut layer.

The method may further include receiving, at a tail network model the first plurality of activations and the second plurality of activations at a cut layer of the split neural network, and generating a model output in response to the first plurality of activations and the second plurality of activations.

The head network model may include a first head neural network of the split neural network and the tail network model may include a tail neural network of the split neural network.

The translator model may include a neural network or a tree-based machine learning model.

The plurality of input feature values may include a first plurality of input feature values, and wherein the translator model predicts an output of a second head neural network of the split neural network that is configured to generate, during a training phase, the second plurality of activations in response to a second plurality of input feature values that are different from the first plurality of input feature values.

The plurality of input feature values may include network features of a wireless communication network, and wherein the model output may include a key performance indicator, KPI, of the wireless communication network.

The model output may include a quality of experience, QoE, metric of the wireless communication network.

The first plurality of input features may include network features of a wireless communication network and the second plurality of input features may include application or user equipment features of the wireless communication network.

The head network model may include a first head network model that is trained as part of a neural network model that includes a second head network model that generates the second plurality of activations during a training phase.

A computer program product comprising a non-transitory computer readable storage medium comprising computer program instructions that, when executed by one or more processors, performs operations including receiving, at a head network model, a plurality of input feature values, generating, by the head network model, a first plurality of activations in response to the plurality of input feature values, providing, by the head network model, the first plurality of activations to a translator model and to a tail network model at a cut layer of the split neural network, receiving, by the translator model, the first plurality of activations, generating, by the translator model, estimated values of a second plurality of activations in response to the first plurality of activations, and providing, by the translator model, the estimated values of the second plurality of activations to the tail network model at the cut layer.

### BRIEF DESCRIPTION OF THE DRAWINGS

FIG. 1 illustrates a user equipment that access remote services from an application server via a communication network that includes a user plane and a control plane.

FIG. 2 illustrates training of a Machine Learning model that predicts Quality of Experience (QoE) based on input features available in the user plane of a communication network.

FIG. 3 illustrates a Federated Learning system.

FIG. 4 illustrates a Split Learning system.

FIG. 5 illustrates a split learning model in a telecommunication environment that includes three head nodes and one tail node.

FIG. 6 illustrates a conventional architecture for Split Learning in a telecommunication system context.

FIG. 7 illustrates a system according to some embodiments that may be implemented during a training phase.

FIG. 8 illustrates a system according to some embodiments that may be implemented during an inference phase.

FIG. 9 illustrates experimental scenarios according to some embodiments.

FIG. 10A illustrates a learning curve performance on a validation set illustrated for isolated NN models versus vertical FL.

FIG. 10B illustrates test set performance compared on multiple scenarios.

FIG. 11A illustrates learning curve performance on a validation dataset illustrated for isolated NN models versus vertical FL.

FIG. 11B illustrates test set performance on a validation set illustrated for isolated NN models versus vertical FL.

FIG. 12A illustrates a learning curve performance on the validation set illustrated for isolated NN models versus vertical FL.

FIG. 12B illustrates test set performance compared on multiple scenarios.

FIG. 13 illustrates the feasibility of the proposed solution with numerical results.

FIG. 14 illustrates a process according to some embodiments.

FIG. 15 illustrates operations according to some embodiments.

FIG. 16 is a block diagram illustrating elements of a network node for estimating QoE according to some embodiments.

FIG. 17 shows an example of a communication system in accordance with some embodiments.

FIG. 18 illustrates operations of a head node in a SL system in an inference phase according to some embodiments.

FIG. 19 illustrates operations of a translator node according to some embodiments.

FIG. 20 illustrates operations of a tail node according to some embodiments.

FIG. 21 illustrates a training phase of a split learning system according to some embodiments.

FIG. 22 illustrates an inference phase of a split learning system according to some embodiments.

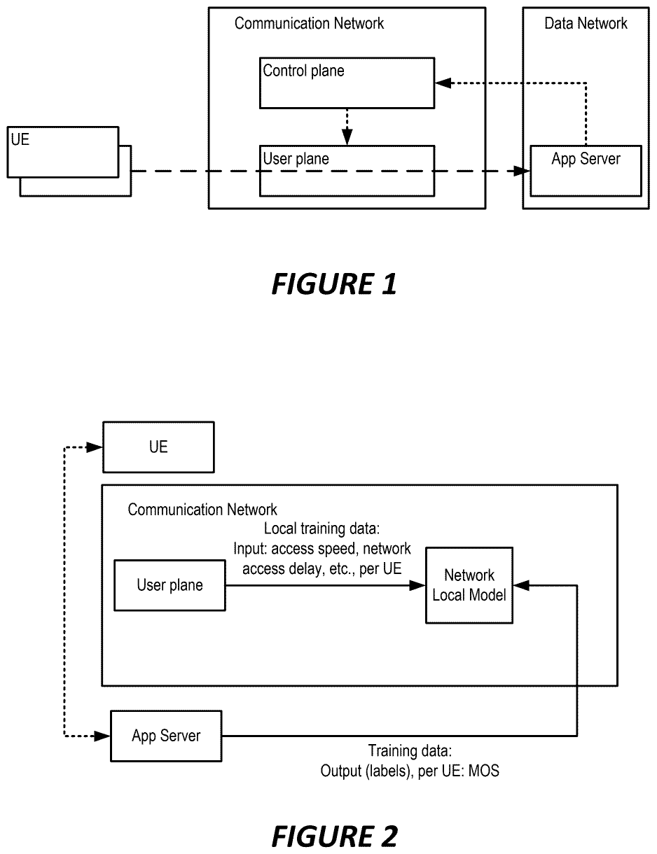

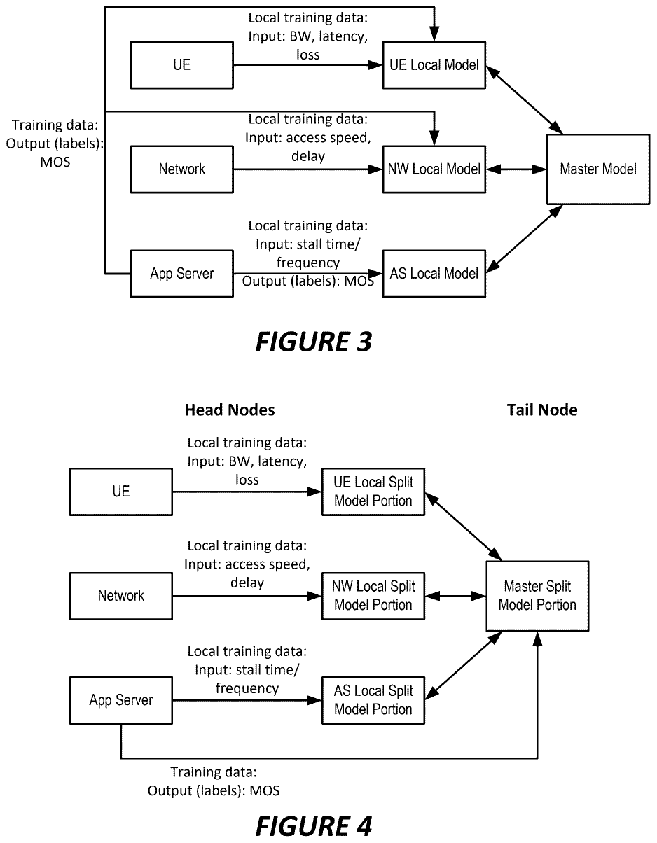

### DESCRIPTION

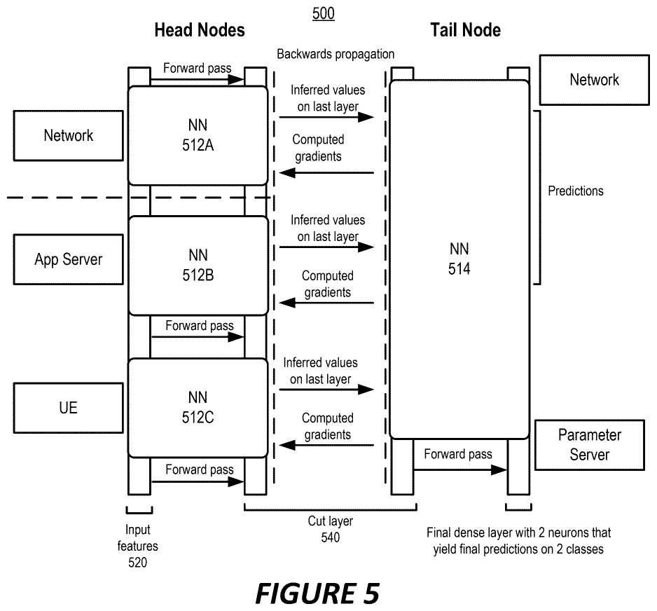

Although Split Learning, such as the system shown in FIG. 5, is a promising approach for used in communication networks, there are some challenges that need to be addressed. For example, once the model is trained, the network still needs to receive activations from the head nodes (e.g., the AppServer and UE), which introduces signaling overhead and requires sample alignment. In the context of a communication system, it would be desirable to have a solution that does not need input from the AppServer and the UE during the inference phase, so that the Network alone can estimate QoE using only its local dataset while simultaneously achieving a level of accuracy that would otherwise not be possible without collaboration. More generally, it would be desirable for a split learning system not to require input from all head nodes during the inference phase following training of the tail node.

Although embodiments are described herein with reference to a split learning system for estimating QoE in a communication system, it will be appreciated that some embodiments may be applied in the context of many different types of systems in which split learning is employed. Moreover, within the context of a communication system, systems and methods for split learning may be employed to estimate other parameters of the system in addition to or instead of QoE.

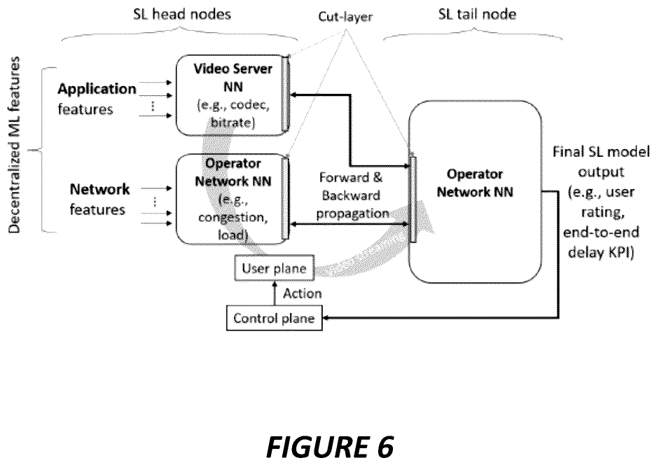

An example of a conventional architecture for SL in a telecommunication context is illustrated in FIG. 6. As shown in FIG. 6, a video server and a network act as collaborators. Head nodes corresponding to the video server and the network are implemented as neural networks (NNs) that receive respective input features, such as codec and bitrate at the video server NN and congestion, load and throughput data at the network NN, and generate activations at a cut-layer. The activations are provided to a tail node, implemented in this example as a NN operated by the network, which receives the activations and responsively generates an output, such as an MOS or other key performance indicators (KPIs). In a training phase, gradients are back-propagated from the tail node to the head nodes for adjusting weights within the video server NN and the network NN based on an error signal. In the inference phase, the MOS output by the tail node is provided to the control plane of the network, and can be used to control the operation of the network, such as by modifying user plane parameters of the network to improve the MOS.

In a typical SL implementation, input observations are needed from all collaborators continuously during the inference phase. This may involve a high signaling overhead. Previously, there have been efforts to reduce network footprint, such as by communicating gradients and/or activations only at selected rounds or epochs during training. For example, gradients and/or activations may only be communicated when the magnitude of the loss value at the server (tail node) is higher than some predefined threshold. Other approaches for reducing network signalling overhead include performing quantization on the gradients with techniques including search-based quantization, or performing multiple local updates before sending out activations to the neural network at the parameter server.

There have been other efforts to perform split learning over the air to reduce transmission costs. Sending gradients based on gradient update magnitudes have also been studied previously, and the gradients that have not changed much during a round of training are set to be redundant during the training are masked out and not exchanged, hence yielding network footprint reduction.

An architecture known as Adasplit has been proposed to personalize the training at the tail node (server) with masking, where collaborating clients only train on “their” sparse partitions of the tail node model at the server side, which restricts them to update the model on other client partitions of the server model.

Such approaches primarily focus on the training phase of SL. In contrast, some embodiments described herein are directed to the inference phase of SL. In particular, some embodiments do not require worker nodes to share information during the SL inference phase.

Embodiments are described herein in the context of a SL scenario in which multiple nodes, such as an Application Server (AppServer), UE and network, are involved and interact during the training phase. It will be appreciated that the embodiments described herein can be generalized to a greater number of collaborating nodes. While multiple nodes are involved in training, a single node of the SL system (e.g., a network) may perform inference without needing input from other nodes. This may reduce the signalling required during the inference phase, and may also obviate the requirement for other nodes to share potentially sensitive and/or private information during the inference phase.

In the present description, the terms “split learning” and “vertical federated learning” (or “SL” and “VFL”) are used interchangeably to refer to a SL model that is trained on split neural networks with “vFL” occurrences.

Some embodiments provide systems/methods that collaboratively train multiple decentralized worker (client) nodes of a SL model in a way that is agnostic to the features available at the worker nodes. The worker nodes may correspond to head nodes in a SL model. In an example application, the head nodes can correspond to a UE, AppServer, and network. In some examples described herein, embodiments will be described only using an AppServer and a network as worker nodes. However, the architecture described herein can be extended to a larger number of collaborating nodes in other use cases.

Some embodiments provide a trained model that performs inference without needing input from all of the head nodes that were used to train the model. This contrasts with the typical split NN shown in FIG. 6, in which inputs from all of the head nodes are used during the inference phase.

For example, in the context of a communication network, instead of receiving activations from an AppServer at a cut-layer, a tail node of a SL system receives activations, which would otherwise have to be received from the AppServer, from a translator model within the network, which generates estimates of the activations. The tail node in the network combines the generated activations with the actual network activations, and estimates the MOS from the combined generated and actual activations.

Training is performed using actual activations from both the AppServer and the network. Thus, during the inference phase, after the joint model has converged, the network can generate estimates of the activations for the AppServer and use those estimates as input to the tail node.

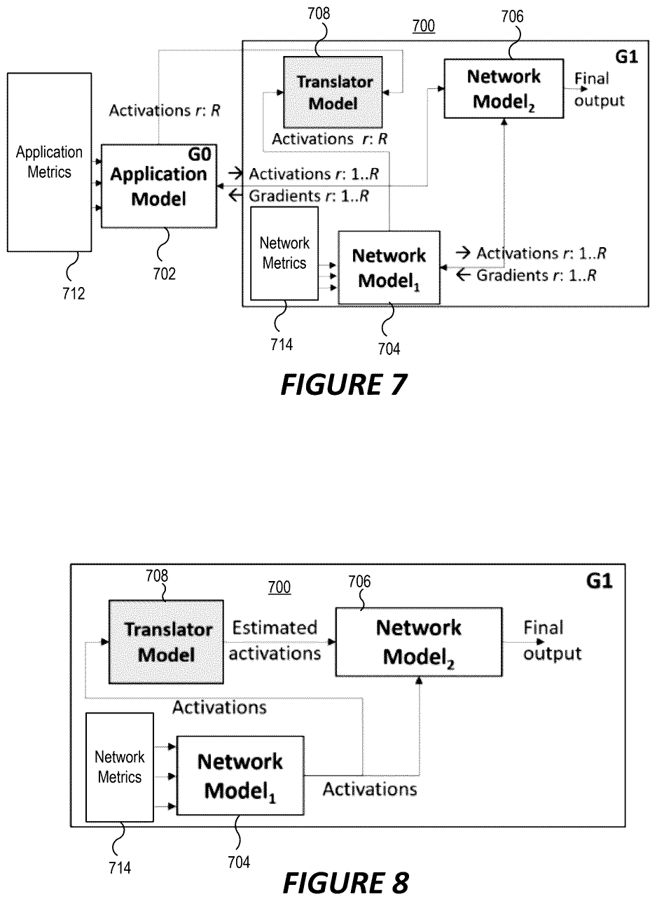

FIG. 7 illustrates a system 700 according to some embodiments that may be implemented during a training phase, and FIG. 8 illustrates the system 700 during an inference phase. In particular, referring to FIG. 7, the system 700 includes an application model 702 and a first network (NW) model 1 704 that act as head nodes, and a second NW model 2 706 that acts as a tail node of a SL system. Although the system 700 is illustrated with two head nodes 702, 704 and one tail node 706, it will be appreciated that the system 700 may include more than two head nodes and/or more than one tail node.

As in the generic SL system shown in FIG. 5, the head nodes are separated from the tail node(s) along a cut layer 540. The application model 702 is implemented in a first isolated group G0, and the network models 1 and 2 704, 706 are implemented in a second isolated group G1. For example, the first isolated group G0 may correspond to an AppServer that is not operated by the network operator, and the second isolated group may correspond to a network that is operated by the network operator, and that is separate and distinct from the first isolated group. The second isolated group G1 may further include a translator model 708, described in more detail below.

The first isolated group G0 serves as a head node and may be implemented as a neural network. The second isolated group G1 serves as both a head node (NW model 1) and a tail node (NW model 2). NW model 1 704 and NW model 2 706b may be implemented as neural networks. However, it will be appreciated that NW model 1 704 and NW model 2 706 can be implemented using other types of ML models. NW model 1, NW model 2 and the translator model may be implemented in the same network function or node or in different network functions or nodes within a communication network.

The application model 702 receives application metrics 712 that are available to the AppServer and generates a first plurality of activations based on the application metrics. Likewise, the NW model 1 704 receives network metrics 714 that are available to the network and generates a second plurality of activations based on the network metrics 714. The application model provides the first plurality of activations to both the NW model 2 and to the translator model. Likewise, the NW model 1 704 provides the second plurality of activations to both the NW model 2 706 and the translator model 708.

The NW model 2 706 receives the first and second plurality of activations, and generates a final output, such as an MOS. In the training phase, an error is calculated, and gradients are propagated back through the application model 702 and the NW model 2 706.

The translator model 708 is trained using the first plurality of activations output by the application model 702 as training labels and the second plurality of activations output by the NW model 1 704 as input features. Accordingly, while the application model 702, NW model 1 704 and NW model 2 706 are trained to generate the final output, the translator model 708 is trained to generate estimates of the first plurality of activations.

The translator model 708 may be implemented as a multi-input multi-output Neural Network (MIMO_NN), or other suitable MIMO model, including a tree-based machine learning model.

Referring to FIG. 8, in the inference phase, the first plurality of activations are not obtained from the application model 702. Rather, estimates of the first plurality of activations are obtained from the trained translator model 708 and used by the NW model 2 706 in place of activations generated by the Application model 702.

The efficacy of the system/method illustrated in FIGS. 7 and 8 may depend strongly on the original contribution of the head nodes (which depends on the input features and samples at the decentralized nodes).

If the application features, and thus the Application node, are originally contributing in a significant way to the NW model 2 706 via the cut-layer (FIG. 5), then as an alternative to maintaining the Application model 702 in the inference phase, the NW model 2 can 706 instead be supplied with estimated values generated by the translator model 708.

If the application features, and thus the Application node, are originally not contributing in a significant way to the corresponding activations at the cut-layer, then the activation matrix at the cut-layer of the application model 702 can be filled in with a default matrix (e.g. a zero-matrix) by the network.

The systems/methods illustrated in FIGS. 7 and 8 may adapt and generalize to any features and nodes, as described in more detail below.

According to some embodiments, a split neural network at a network function, such as a network data acquisition function (NWDAF) in a 5G/New Radio network, may generate an output, such as an MOS or other parameter, without needing features and activations from all other nodes, such as UE or an application server, during the inference phase while still achieving a desired level of accuracy, due to the benefit of having joint decentralized training of the SL system.

Systems and/or methods described herein may perform, at an inference phase during deployment, an estimate of QoE (or other parameter) at a network node that does not have access to application server and/or UE input observations/data, such as playout bitrate, stalling events, inter-packet departing time, video codec, resolution, content type and name, etc. This may reduce the exposure of privacy-sensitive data from a worker/client node. In addition, some embodiments may reduce the signaling overhead during the inference phase, and thus the network footprint significantly between the collaborating nodes, as there is no delivery of data or extra signaling needed for synchronization of datasets. The energy consumption is expected to be reduced also as there is no computation and transfer of activations required from other worker nodes.

As noted above, in the inference phase, a network that does not have access to application metrics may generate application activations on behalf of an application server using only locally available network-level observations. The network combines the estimated activations with available network activations and generates an output based on the estimated and actual activations.

Due to the scarcity for access to the real QoE dataset that contains metrics measured from different layers in the stack (e.g., radio, network, application, UE), an experimental scenario was created in which a network group was trained alone (referred to as an isolated scenario). Application server metrics were simulated with features, using a key-value store (KVS) dataset, that were alone slightly better in estimating QoE than the network node metrics alone. The collaborating nodes were trained in a split learning setting until model convergence (referred to as the SL scenario), and then trained in isolation without collaborative training. The same NN model architecture (same number of neurons, layers, batch size, learning rate, same number of rounds) was used in both the isolated and SL scenarios.

In the isolated network scenario, the activations of the network were fed as if they were the activations of the application server, i.e., the concatenated matrix of activations contained only network activations that are two duplicates of the real network activations. This was repeated for the isolated application server scenario, i.e., only application activations were combined (two duplicates of the application activations) and fed to a separate neural network in the application server that contained same number of layers and neurons with NN2 at the network.

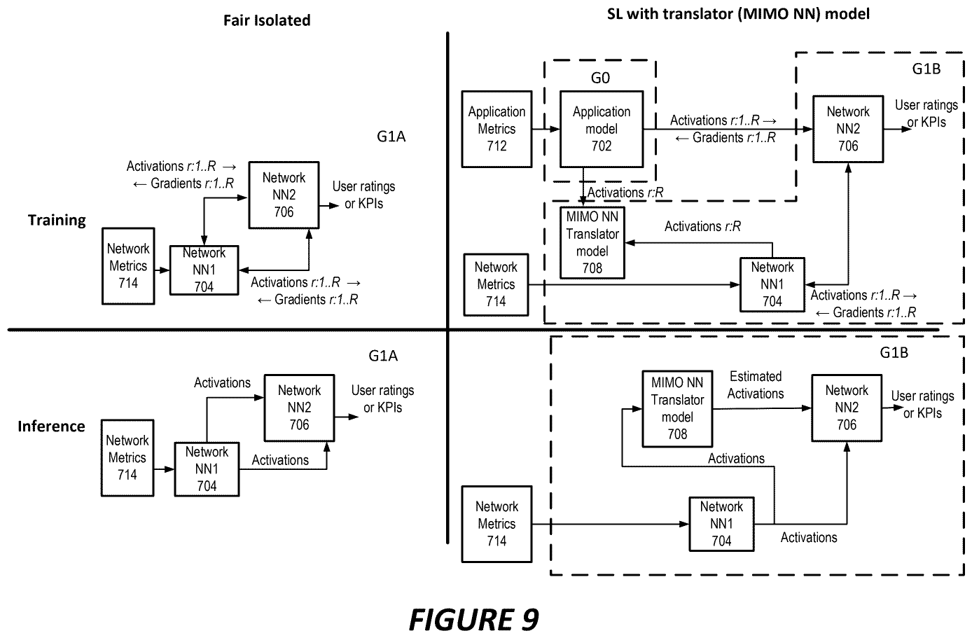

Experimental scenarios are illustrated in FIG. 9. In particular, FIG. 9 illustrates topologies for training phase (upper portion) and inference phase (lower portion) for both the isolated scenario (left side) and SL scenario (right side). In the isolated scenario, a single group (G1A) corresponding to a network includes a head NN 1 704 and a tail NN2 706. In the SL scenario, a first group G0 corresponding to a worker includes a head model (Application model 702), and a second group G1B corresponding to a network includes a head model NN1 704, a tail model NN2 706 and a translator model 708 which may be implemented as a MIMO NN. The application model 702 is only present during the training phase, as the activations generated by the application model 702 are supplied by the translator model 708 during the inference phase.

Training of isolated scenario at the Network node.

The network metrics at group 1 (G1A) are fed as input to the first neural network (NN1) 704 and the activations are sent to the second neural network (NN2) 706. The same activations are concatenated at the first interface cut-layer of NN2 706. Next a forward-pass operation (linear transformation followed by non-linear ones) on the concatenated activations is performed until the last layer of NN2 706. At the last layer of NN2 706, the loss (difference between the estimated and the actual output) is computed. Next, the gradients are calculated at NN2 706. The snapshot gradients at the first layer of NN2 706 are split, and one of the split is sent to the NN1 704. NN1 704 continues further backwards-propagation to compute the gradients until its first input layer. All weights on both NN1 704 and NN2 706 are updated. The above is repeated until a saturation point (at an acceptable level) of model accuracy is reached.

### Inference of Isolated Scenario at the Network Node.

The network metrics at group 1 (G1A) are fed as input to the first neural network NN1 704 and the activations are sent to the second neural network NN2 706. The same activations are concatenated at the first interface cut-layer of NN2 706. Next a forward-pass operation (linear transformation followed by non-linear ones) on the concatenated activations is performed until the last layer of NN2 706. At the last layer of NN2 706, the final output of the model is extracted and is considered as the final estimated value for the given input.

Training of SL at the Network Node with Application Assistance (SL with Translator Model).

The Application metrics at group 0 (G0) are fed as input to the Application model 702 (which may be a NN) and the activations are sent to the second neural network NN2 706 at G1B.

The network metrics at group 1 G1B are fed as input to the first neural network NN1 704 and the activations are sent to the second neural network NN2 706.

Next a forward-pass operation (linear transformation followed by non-linear ones) on the concatenated activations is performed until the last layer of NN2 706. At the last layer of NN2 706, the loss (difference between the estimated and the actual output) is computed. Next, the gradients are calculated at NN2 706. The snapshot gradients at the first layer of NN2 706 are split, and one of the split is sent to the NN1 704. The other split is sent to the Application model 702. NN1 704 and the application model 702 continue further backwards-propagation to compute the gradients until first input layers. All weights of the neural networks are updated.

After the SL reaches a saturation point (e.g., an acceptable level of accuracy is obtained), then the application performs forward pass with the training samples on the trained local neural network (Application model 702) and sends the activations to G1B. G1B feeds in the received activations to its translator model 708 as target variables. Simultaneously, the network performs a forward-pass with the training samples on the input features (to NN1 704) and sets the activations of NN1 704 as inputs of to the translator model 708. The translator model 708 is trained until model convergence.

Inference of SL at the Network Node without Application Metrics.

The network performs forward-pass on the local input features and sends the activations to the translator model 708 as inputs. The translator model 708, which may be a pre-trained MIMO NN, estimates the application activations from the network activations. Both the estimated application activations and the actual network activations are fed as input to the second neural network NN2 706 at G1B. Finally, the output (such as user rating, etc.) is computed at G1B.

A set of experiments was performed to obtain empirical results, baseline comparison, and validate the SL systems/methods described above.

In the experimental scenario, an Isolated_g0: Group 0 (G0) trains a local neural network with the same neural network architecture of split learning (number of layers, neurons per layer, and other hyperparameters) with local group 0 (G0) features (without features from G1A). This is illustrated in the left hand-side of FIG. 9 (with replacement of Network NN1 with Application model. In addition there is a secondary neural network NN2 with exact same layers and neurons with Network NN2 706.)

An Isolated_g1: Group 1 (G1A) trains a local neural network with the same neural network architecture of split learning (number of layers, neurons per layer, and other hyperparameters) with local group 1 features (without features from G0). This is illustrated in the left hand-side of FIG. 9. The following scenarios were simulated in the experiment:
vFL_actual_g0_activations: SL with actual group 0 and group 1 activations.
vFL_generated_g0_activations: SL with generated group 0 activations and actual group 1 activations via proposed MIMO NN.
vFL_baseline_zeros_g0_activations: SL with group 0 activations with zero matrix.
vFL_baseline_zeros_g0_g1_activations: SL with group 0 and group 1 activations via zeros matrix.
vFL_baseline_random_g0_activations: SL with group 0 activations via random matrix.
vFL_baseline_random_g0_g1_activations: SL with group 0 and group 1 activations via random matrix

Experiment 1: Both Application Group 0 and Network Group 1 had moderate features (19 features each) and they both benefit from each other since SL accuracy is the highest amongst the three scenarios, i.e., Isolated_g0, Isolated_g1, and vFL_actual_g0_activations. In this experiment, the results obtained from the inventive concepts are compared (vFL_generated_g0_activations), where no activations shared by Application. The results are on-par with the vFL_actual_g0_activations, still obtaining higher accuracy values as compared to the scenario where Network trains alone in isolation.

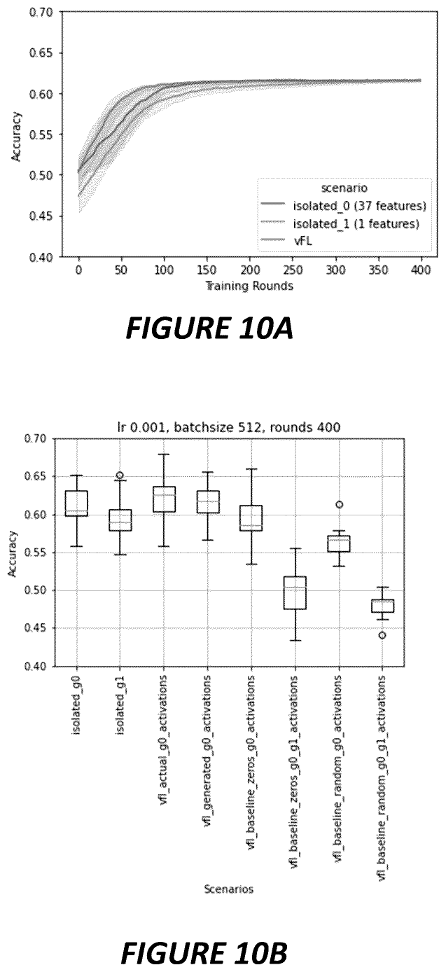

FIG. 10A illustrates a learning curve performance on the validation set illustrated for isolated NN models versus a vertical FL system. FIG. 10B illustrates test set performance compared on multiple scenarios. The generated activations via MIMO_NN reaches on-par accuracy with the actual activations from Application node.

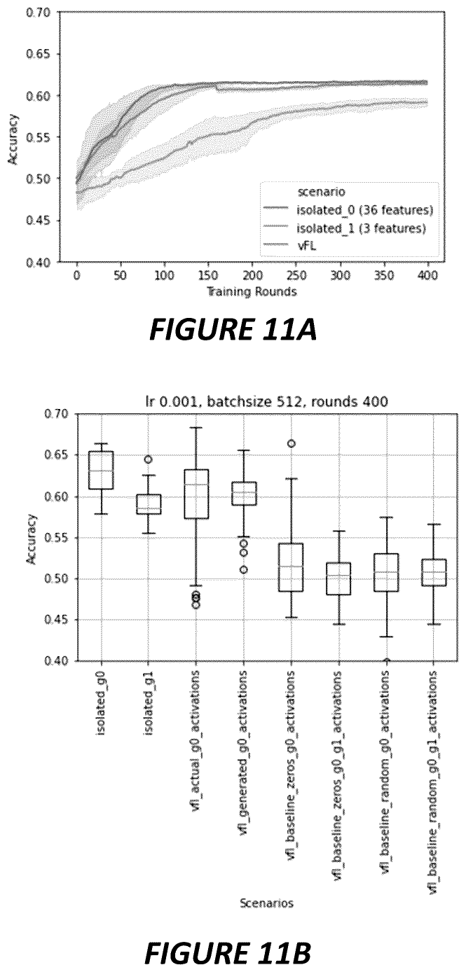

Experiment 2 (Application Group 0 has strong features, Network Group 1 has 3 moderate features): FIG. 11A illustrates the learning curve performance on the validation dataset. The learning curve indicates that the isolated group 1 with weak features (only 3 features) clearly benefits from SL (higher final validation accuracy and faster model convergence). Furthermore, the same was validated in the test set. Again, the results obtained from the inventive concepts (vFL_generated_g0_activations) are compared, where no activations shared by Application. The results are on-par with the vFL_actual_g0_activations, still obtaining higher accuracy values as compared to the scenario where Network trains alone in Isolation.

FIG. 11B illustrates the test set performance on the validation set illustrated for isolated NN models vs the vertical FL. On the right, test set performance compared on multiple scenarios. The generated activations via MIMO_NN reaches on-par accuracy with the actual activations from Application node.

Experiment 3: (Application Group 0 has strong/moderate features and Network Group 1 has too weak features):

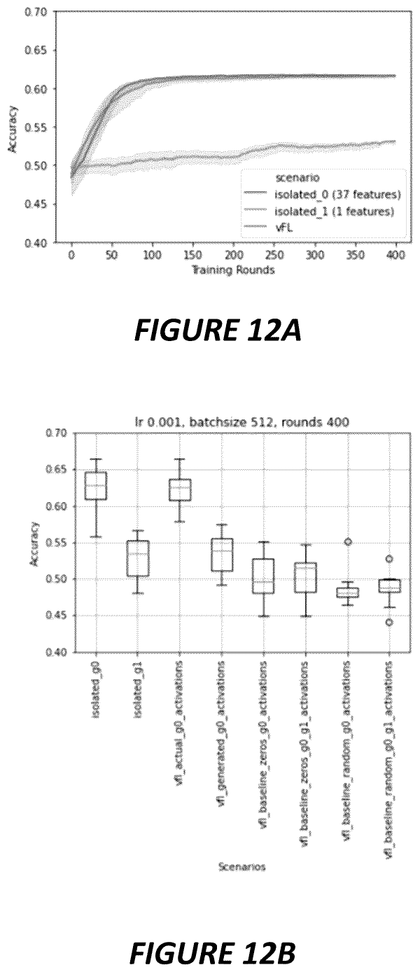

If the network group 1 has too weak features (as in this experiment), the MIMO translator model cannot learn to estimate the application activations from very noisy input Network activations. Therefore, the generated activations will be noisy, and so the final result of the split learning model is poor as seen in the experiment results shown in FIGS. 12A and 12B.

In particular, FIG. 12A illustrates a learning curve performance on the validation set illustrated for isolated NN models vs the vertical FL. FIG. 12B illustrates test set performance compared on multiple scenarios. The generated activations via MIMO_NN does not reach on-par accuracy with the actual activations from Application node due to the existence of at least one too-weak.

Although Experiment 1 and 2 are realistic QoE model training scenarios, scenario 3 can also happen in some cases. It is clear from the results of Experiment 3 that there are corner case scenarios where the solution would not be feasible especially the scenario as such when isolated network model accuracy (or any of the involved collaborating node accuracy) is too poor. Table 1 summarizes the results.

TABLE 1
Efficacy of Generated Activations

| Scenarios | Efficacy of generated activations |
|---|---|
| Experiment 1 and 2. Moderate | The solution is feasible and SL |
| IsolatedNetwork, moderate/good | benefits Network in this scenario. |
| Isolated Application accuracy. SL | |
| has higher accuracy than Isolated | |
| Network accuracy. | |
| Experiment 3: Too weak Isolated | In this case, the application would |
| Network, too weak Isolated | not contribute to the federation, i.e., |
| Application accuracy. | the activation split from application |
| | node would be noisy. Hence, MIMO |
| | is not necessary, instead the |
| | activations for application can be |
| | fed with zero-matrix during |
| | inference. |

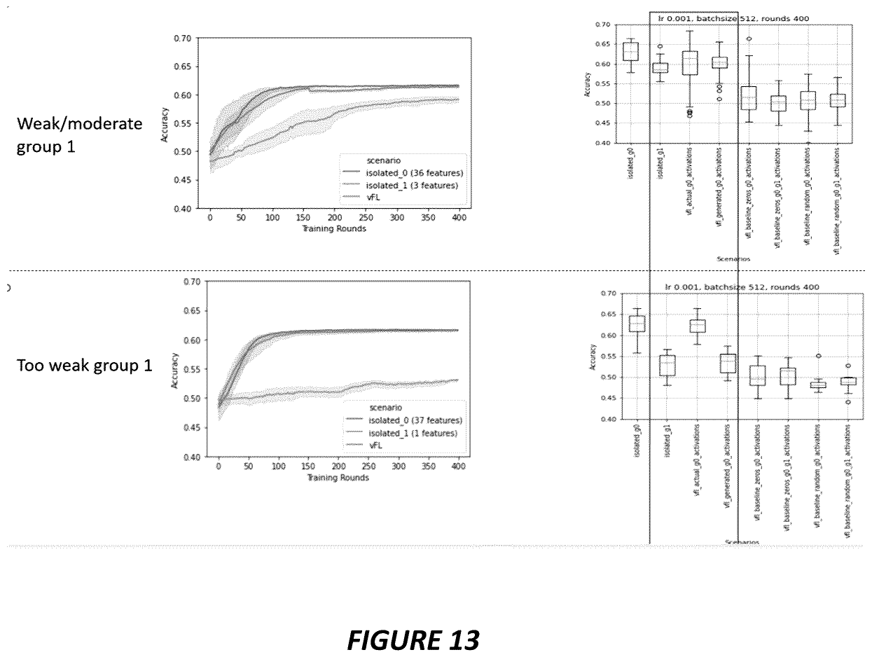

FIG. 13 illustrates the feasibility of the proposed solution with numerical results. The SL performs well and is feasible on the first scenario (top) where both collaborators do not have too weak representation of the target variable. In the scenario presented at the bottom, where one of the collaborators is too weak, the solution is not as preferable.

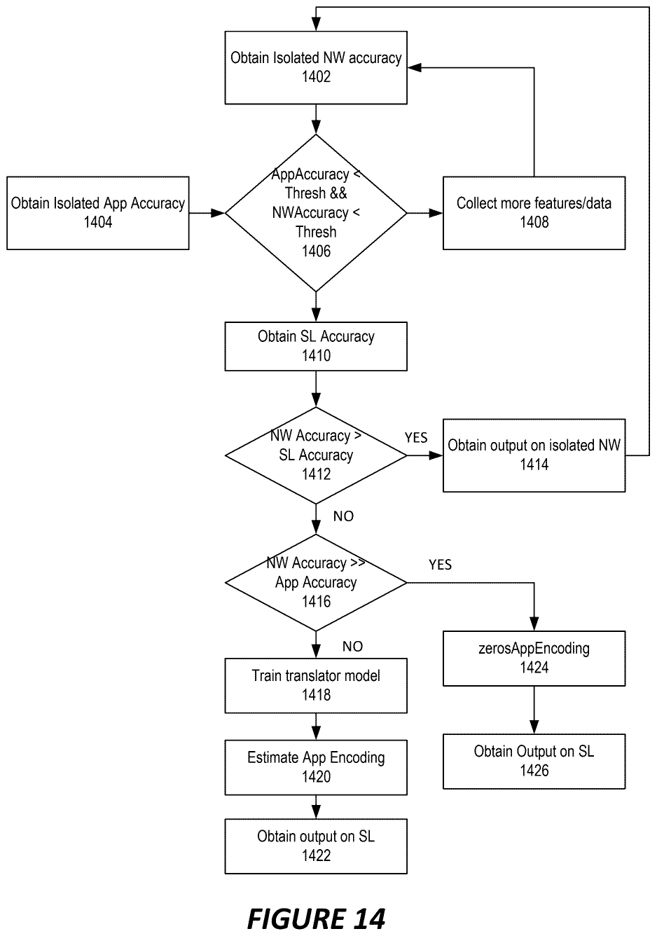

To address the scenario at the bottom of FIG. 13, the process shown in the flowchart FIG. 14 may be used. Referring to FIG. 14, accuracy of an isolated network model and isolated AppServer model are obtained at blocks 1402 and 1404 and evaluated at block 1406. If the AppServer model accuracy and the network model accuracy are both less than a predetermined respective threshold, the system collects more features and data at block 1408 and continues to train the isolated models.

Otherwise, the accuracy of the SL system is obtained at block 1410. The accuracy of the SL system is compared to the isolated network accuracy at block 1412. If the isolated network accuracy is greater than the SL accuracy, then the system obtains output using the isolated network system at block 1414 and operations return to block 1402.

The isolated network accuracy is compared to the isolated AppServer accuracy at block 1416. If the network accuracy is much greater than the isolated AppServer accuracy, then zeros encoding is used for the AppServer model (i.e., AppServer activations are set to zeros) at block 1424 and an output is obtained using the split learning system at block 1426.

Otherwise, a MIMO neural network is trained at block 1418, which is used to estimate the AppServer encoding at block 1420, and the output of the SL system is obtained at block 1422.

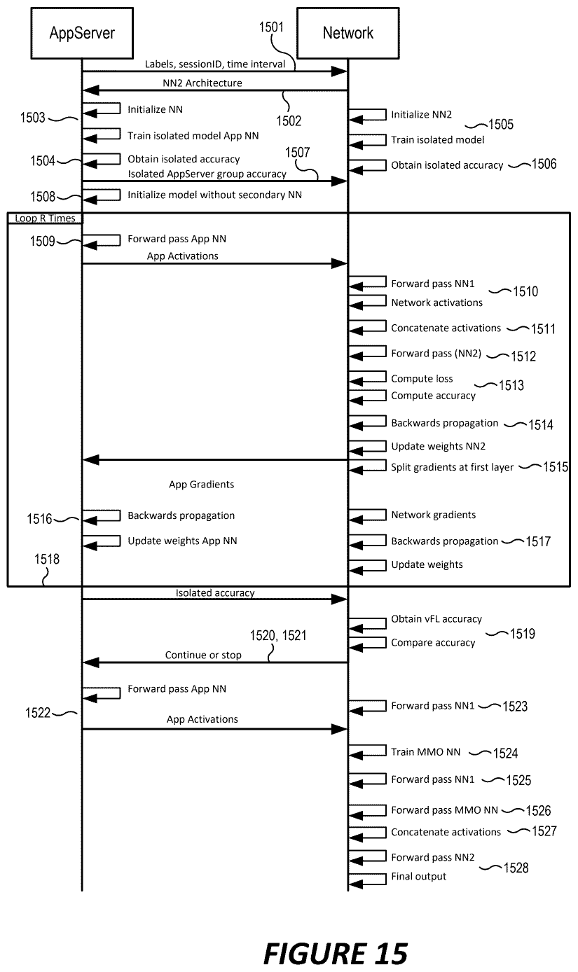

FIG. 15 illustrates operations according to some embodiments. In the operations of FIG. 15, a network implements the first network NN1 704, second network NN2 706 and MIMO NN translator model 708 of FIG. 9, while an application server (AppServer) implements the application model 702 of FIG. 9. Referring to FIG. 15, the operations disclosed therein are described as follows.

As the efficacy of the proposed SL highly depends on the isolated group accuracies, federation is performed on three scenarios for comparison with baseline: i) isolated AppServer training, ii) isolated Network training, iii) joint SL training with AppServer and Network node.
Step 1501. The AppServer sends a timestamp or key identifier (e.g., a label such as user rating, session id, time interval) so that the Network and the AppServer can align the samples.
Step 1502. The Network sends the NN2 model architecture to the AppServer. This is necessary for the Isolated training at the AppServer.
Step 1503. The AppServer initializes and trains an Isolated model with the received NN2 architecture without exchanging gradients or activations with the Network, but instead while using local AppServer gradients and activations.
Step 1504. The AppServer records the Isolated AppServer group accuracy.
Step 1505. The Network initializes and trains an Isolated model with the same NN2 architecture sent to the AppServer without exchanging gradients or activations with the AppServer.
Step 1506. The Network records the Isolated Network group accuracy.
Step 1507. The AppServer sends the isolated AppServer group accuracy to the Network, and the Network compares it with the local Isolated network group accuracy. If any of the two accuracies are too low, below some threshold tau, the network and the application node is asked to collect more observations with respect to ML features and samples and retrain. Therefore, the procedure goes back to Step 1501. Else, training continues with Step 1508.
Step 1508. The AppServer initializes another model (part of SL NN, i.e. App_NN or application model 702) and now without the secondary neural network.
Step 1509. The AppServer performs forward-pass and computes activations via the application model 702 and sends to the Network.
Step 1510. The Network generates activations via the first local neural network NN1 704.
Step 1511. The Network concatenates the AppServer activations with the Network activations.
Step 1512. The Network performs forward-pass on the concatenated activations on the second neural network NN2 706, and yields the output.
Step 1513. The Network performs computation of loss with the user ratings previously shared by the AppServer.
Step 1514. The Network performs backwards-propagation until the first layer of the second neural network NN2 706.
Step 1515. The Network splits the gradients at the first layer of the second neural network NN2 706 to the Application and the Network.
Step 1516. The AppServer performs backwards-propagation until the first layer of the application model 702.
Step 1517. The Network performs backwards-propagation until the first layer of the first local neural network NN1 704.
Step 1518. Steps 1509-1517 are repeated until model accuracy convergence. A model convergence is defined by either (1) a target accuracy is reached in the case when the target accuracy is higher than the saturation accuracy, or (2) the accuracy does not increase significantly over more rounds of training.
Step 1519. The Network evaluates the SL model accuracy and compares all three scenario accuracies, i.e., isolated AppServer, isolated Network, and joint training of SL.
Step 1520. If the isolated Network accuracy is less than the SL accuracy, training continues with Step 1521, otherwise the Network performs inference in isolation, and in parallel reinitiates process with Step 1501 to continue exploring the benefit of SL with more samples and features. The Application node is asked to collect more observations with respect to ML features and samples and retrain.
Step 1521. When the SL accuracy is higher than Isolated network accuracy, and if the Network accuracy is significantly higher than the Application accuracy, there would be no need for a translator model 708, as the application model 702 would not contribute to the joint model, hence then the process continues with Step 1529. In other words, if the application model 702 does not contribute, NN2 weights that connect to the application model 702 would be too noisy, and one can send in any activation to those as input, and NN2 accuracy would not change. For that reason, there is no need to generate application activations via the translator model 708 at all, but instead Network just zeros out the Application activations and feeds them to NN2 instead.

When the SL accuracy is higher than Isolated network accuracy, and if the AppServer accuracy is significantly higher than the Network accuracy, then continue on with Step 1522.
Step 1522. The AppServer generates activations on the whole training set via the application model 702 and sends to the Network.
Step 1523. The Network generates activations on the whole training set via the first local neural network NN1 704.

The reason that activations are generated on the training set at the end of SL convergence is because the activations need to be reasonable with reduced noise and reduced entropy (i.e., should be the outputted by converged, and well-trained neural networks).
Step 1524. A multi-input multi-output (MIMO) translator model 708 that translates network activations to AppServer activations is trained with the data received at steps 1522 and 1523. In this training, the input of the model is the Network activations, output (target variable) is the AppServer activations. At the end of this stage, the translator model 708 is trained.
Step 1525. The Network generates activations on the whole test set via the first local neural network NN1 704.
Step 1526. The Network generates estimated AppServer activations (with input of Network activations on the testset) on the whole test set via the translator model 708.
Step 1527. The Network concatenates the estimated AppServer activations with the Network activations.
Step 1528. The Network performs forward-pass on the concatenated activations on the second local neural network NN2 706, and yields the final output.

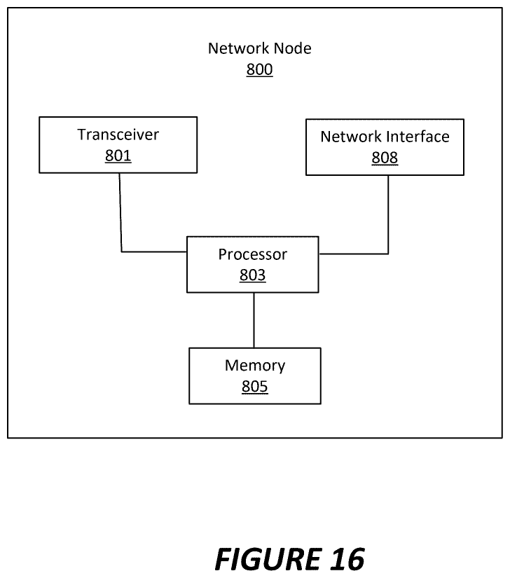

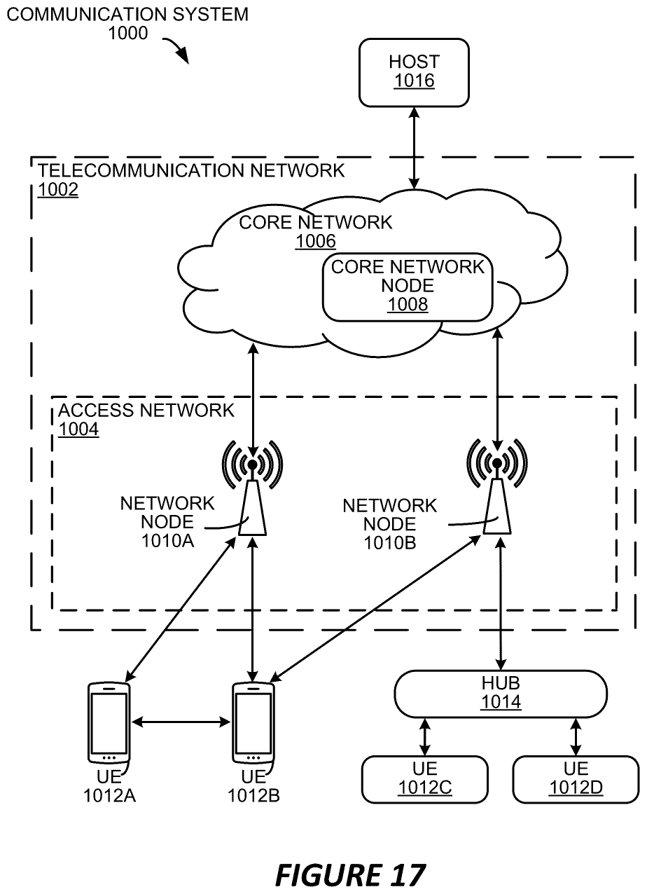

FIG. 16 is a block diagram illustrating elements of a network node 800 for estimating QoE according to some embodiments. Device 800 may be provided by, e.g., a device in the cloud running software on cloud computing hardware; or a software function/service governing or controlling a wireless communication network. That is, the device may be implemented as part of a communications system (e.g., a device that is part of the communications system 1000 as discussed below with respect to FIG. 17), or on a device as a separate functionality/service hosted in the cloud. The device also may be provided as a standalone software for managing a wireless communication network; and the device may be in a deployment that may include virtual or cloud-based network functions (VNFs or CNFs) and even physical network functions (PNFs). The cloud may be public, private (e.g., on premises or hosted), or hybrid.

As shown, the device may include transceiver circuitry 800 (e.g., RF transceiver circuitry) including a transmitter and a receiver configured to provide uplink and downlink radio communications with devices (e.g., a controller for automatic execution of actuations). The device may include network interface circuitry 808 (also referred to as a network interface,) configured to provide communications with other devices (e.g., a controller for automatic execution of an actuation). The device may also include processing circuitry 803 (also referred to as a processor) coupled to the transceiver circuitry, memory circuitry 805 (also referred to as memory) coupled to the processing circuitry.

As discussed herein, operations of the device may be performed by processing circuitry 803, network interface 808, and/or transceiver 801. For example, processing circuitry 803 may control the device 800 to perform operations according to embodiments disclosed herein. Processing circuitry 803 also may control transceiver 801 to transmit downlink communications through transceiver 801 over a radio interface to one or more devices and/or to receive uplink communications through transceiver 801 from one or more devices over a radio interface. Similarly, processing circuitry 803 may control network interface 808 to transmit communications through network interface 808 to one or more devices and/or to receive communications through network interface from one or more devices. Moreover, modules may be stored in memory 805, and these modules may provide instructions so that when instructions of a module are executed by processing circuitry 803, processing circuitry 803 performs respective operations (e.g., operations discussed below with respect to example embodiments relating to devices). According to some embodiments, device 800 and/or an element(s)/function(s) thereof may be embodied as a virtual device/devices and/or a virtual machine/machines.

According to some other embodiments, a device may be implemented without a transceiver. In such embodiments, transmission to a wireless device may be initiated by the device 800 so that transmission to the wireless device is provided through a device including a transceiver (e.g., through a base station). According to embodiments where the device includes a transceiver, initiating transmission may include transmitting through the transceiver.

FIG. 17 shows an example of a communication system 1000 in accordance with some embodiments.

In the example, the communication system 1000 includes a telecommunication network 1002 that includes an access network 1004, such as a RAN, and a core network 1006, which includes one or more core network nodes 1008. The access network 1004 includes one or more access network nodes, such as network nodes 1010a and 1010b (one or more of which may be generally referred to as network nodes 1010), or any other similar 3rd Generation Partnership Project (3GPP) access node or non-3GPP access point. The network nodes 1010 facilitate direct or indirect connection of a user equipment (UE), such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 17 enables connectivity between the UEs, network nodes, hosts, and devices. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b).

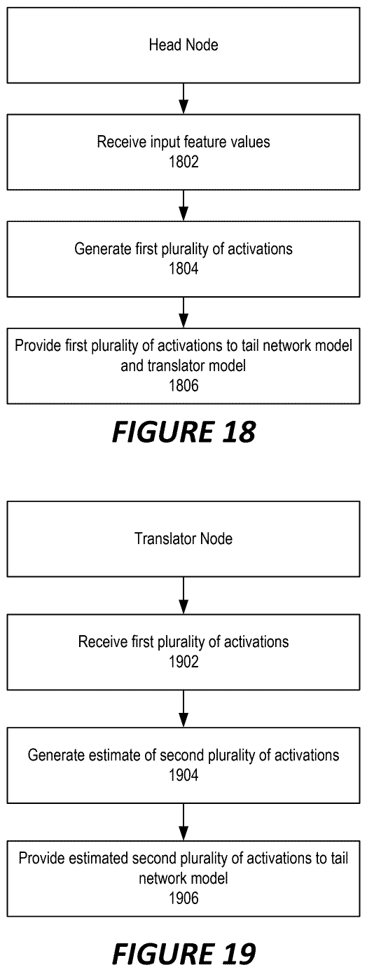

FIG. 18 illustrates operations of a head node in a SL system in an inference phase according to some embodiments. As shown therein, a head node receives input feature values (block 1802) and generates a first plurality of activations based on the input feature values (block 1804). The head node sends the first plurality of activations to a tail network model and to a translator model (block 1806).

FIG. 19 illustrates operations of a translator node according to some embodiments. The translator node receives a first plurality of activations from a head node (block 1902) and generates a second plurality of activations based on the first plurality of activations (block 1904). The translator node provides the second plurality of activations to a tail node (block 1906).

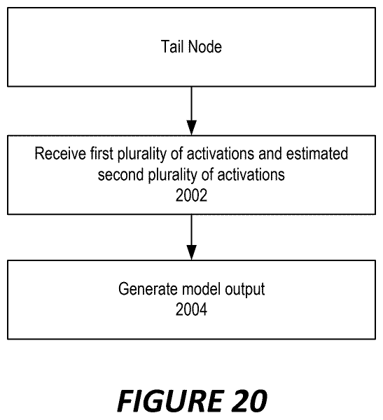

FIG. 20 illustrates operations of a tail node according to some embodiments. The tail node receives the first plurality of activations and the second plurality of activations (block 2002), and generates a model output, such as a MOS, based on the first plurality of activations and the second plurality of activations (block 2004).

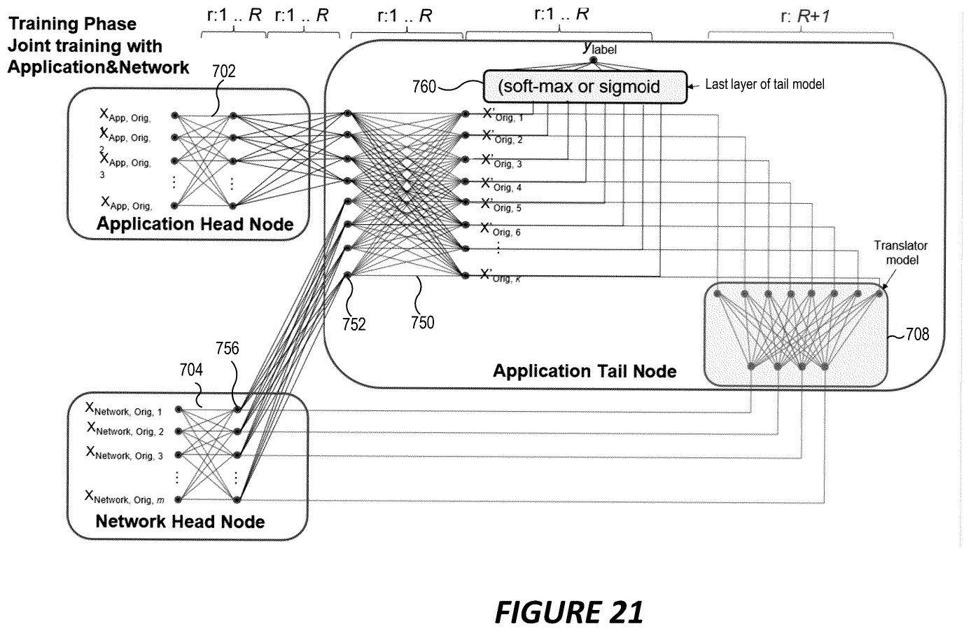

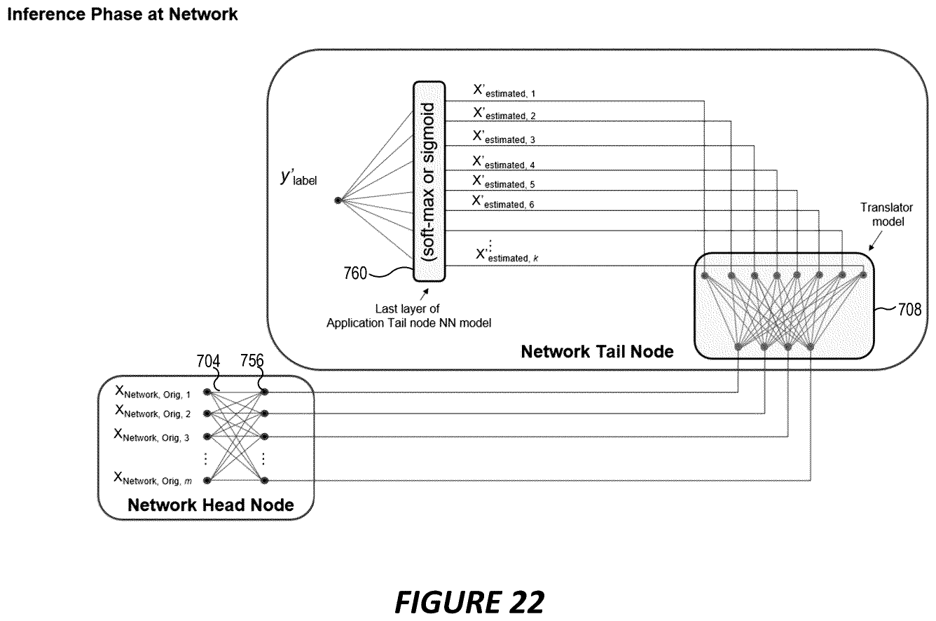

In some embodiments, no labels may be shared from one or more of the head nodes to the tail node (e.g., labels from the AppServer node may not be shared with the network node.) In that case, the following procedure may be performed with reference to FIG. 21 (training phase) and FIG. 22 (inference phase).

Referring to FIG. 21, in the SL training phase, the Network head node performs a forward pass and sends activations to the AppServer, which implements an application tail model 750. The AppServer performs a forward pass on the application head model 702 and concatenates activations with those received from Network.

The application tail model 750 has a Sigmoid or soft-max layer at the last layer 760, and computes the error in estimation.

AppServer performs backward propagation until the cut-layer 752 of the tail node model 750, i.e., the first layer, and splits the gradients to the Application and Network head nodes.

The AppServer and Network head nodes perform backward-propagation.

Assuming that SL converged at this point, the Network sends its activations 756 to the AppServer at the cut-layer 752.

The AppServer trains a translator model 708 with the activations 756 received from the Network. The input to the translator model 708 is the cut-layer activations 756 from the network head node model, and the output is the output of the tail node observed before the last layer (N-1 layer).

The AppServer sends both the trained translator model 708 and only the last layer 760 of the tail node to the Network.

In the inference phase, the Network performs forward-pass and obtains activations 756.

The activations 756 are translated to the tail node activations using the translator model 708 (observed at N-1 layer of tail node).

The translated activations are input to the last layer 760 of the tail model.

Estimations are obtained at the Network.

The results of various approaches described herein are summarized in Table 2.

TABLE 2
Accuracy Results

| Scenario | Accuracy (Std err of mean, Std dev) |
|---|---|
| Application sends actual gradients | 0.891 (0.006) |
| NW uses translator model for | 0.748 (0.009) |
| Application activation estimates | |
| NW randomly selects Application | 0.620 (0.03) |
| activations | |
| NW zeros out Application | 0.648 (0.031) |
| activations | |

Although the devices described herein may include the illustrated combination of hardware components, other embodiments may comprise computing devices with different combinations of components. It is to be understood that these devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the device, and/or performing one or more operations based on the obtained information or converted information, and as a result of said processing making a determination. Moreover, while components are depicted as single boxes located within a larger box, or nested within multiple boxes, in practice, devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the device, but are enjoyed by the device as a whole, and/or by end users and a wireless network generally.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A split neural network system, comprising:
a tail network model that receives a first plurality of activations and a second plurality of activations at a cut layer of the split neural network, and that generates a model output in response to the first plurality of activations and the second plurality of activations;
a head network model that receives a plurality of input feature values and generates the first plurality of activations in response to the plurality of input feature values and provides the first plurality of activations to the tail network model at the cut layer; and
a translator model that receives the first plurality of activations, that generates estimated values of the second plurality of activations in response to the first plurality of activations, and that provides the estimated values of the second plurality of activations to the tail network model at the cut layer.

2. The split neural network system of claim 1, wherein the head network model comprises a first head neural network of the split neural network and the tail network model comprises a tail neural network of the split neural network.

3. The split neural network system of claim 1, wherein the translator model comprises a neural network or a tree-based machine learning model.

4. The split neural network system of claim 3, wherein the plurality of input feature values comprises a first plurality of input feature values, and wherein the translator model predicts an output of a second head neural network of the split neural network that is configured to generate, during a training phase, the second plurality of activations in response to a second plurality of input feature values that are different from the first plurality of input feature values.

5. The split neural network system of claim 1, wherein the plurality of input feature values comprise features related to the operation of a wireless communication network, and wherein the model output comprises a key performance indicator, KPI, of the wireless communication network.

6. The split neural network system of claim 5, wherein the model output comprises a quality of experience, QoE, metric of the wireless communication network.

7. The split neural network system of claim 4, wherein the first plurality of input features comprise network features of a wireless communication network and the second plurality of input features comprise application or user equipment features of the wireless communication network.

8. The split neural network system of claim 1, wherein the head network model and the tail network model are implemented in different network functions of a wireless communication network.

9. The split neural network system of claim 1, wherein the head network model comprises a first head network model that is trained as part of a neural network model that includes a second head network model that generates the second plurality of activations during a training phase.

10. The split neural network system of claim 9, wherein the first head network model, the tail network model and the translator model are operated by a communication network, and the second head network model is operated by an application server that is outside the communication network.

11. A computer-implemented method of operating a split neural network, comprising:
receiving, at a head network model, a plurality of input feature values;
generating, by the head network model, a first plurality of activations in response to the plurality of input feature values;
providing, by the head network model, the first plurality of activations to a translator model and to a tail network model at a cut layer of the split neural network;
receiving, by the translator model, the first plurality of activations;
generating, by the translator model, estimated values of a second plurality of activations in response to the first plurality of activations; and
providing, by the translator model, the estimated values of the second plurality of activations to the tail network model at the cut layer.

12. The method of claim 11, further comprising:
receiving, at a tail network model the first plurality of activations and the second plurality of activations at a cut layer of the split neural network; and
generating a model output in response to the first plurality of activations and the second plurality of activations.

13. The method of claim 11, wherein the head network model comprises a first head neural network of the split neural network and the tail network model comprises a tail neural network of the split neural network.

14. The method of claim 11, wherein the translator model comprises a neural network or a tree-based machine learning model.

15. The method of claim 14, wherein the plurality of input feature values comprises a first plurality of input feature values, and wherein the translator model predicts an output of a second head neural network of the split neural network that is configured to generate, during a training phase, the second plurality of activations in response to a second plurality of input feature values that are different from the first plurality of input feature values.

16. The method of claim 11, wherein the plurality of input feature values comprise network features of a wireless communication network, and wherein the model output comprises a key performance indicator, KPI, of the wireless communication network.

17.-20. (canceled)
